(19) United States
(12) Patent Application Publication
(10) Pub. No.: US 2008/0013773 A1
(43) Pub. Date: Jan. 17, 2008

(54) IN-EAR TYPE AND EAR-PLUG TYPE EARPHONE WITH ADJUSTABLE AREA OF SOUND HOLE ON HOUSING BEHIND SPEAKER

(75) Inventor: Bill Yang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: COTRON CORPORATION, Taipei City (TW)

(21) Appl. No.: 11/530,031

(22) Filed: Sep. 8, 2006

(30) Foreign Application Priority Data
Jun. 29, 2006 (TW) 95123492

(51) Int. Cl. H04R 25/00

(52) U.S. Cl. 381/379

(57) ABSTRACT

An earphone with adjustable area of sound holes on a housing behind the speaker is provided, which includes a speaker unit, a housing and a cover plate. The speaker unit is covered by the housing having at least one adjustable sound hole located thereon behind the speaker unit. In addition, the cover plate is disposed on the housing and used to selectively cover at least one of the adjustable sound holes. The cover plate is a pivoting plate or a sliding plate for adjusting the exposed area of the adjustable sound holes, such that the frequency response of the sound sent by the speaker unit varies depending upon the requirements of customers.

### CROSS-REFERENCE TO RELATED APPLICATION

This application claims the priority benefit of Taiwan application serial no. 95123492, filed Jun. 29, 2006. All disclosure of the Taiwan application is incorporated herein by reference.

### BACKGROUND OF THE INVENTION

1. Field of Invention

The present invention relates to an earphone, and more particularly, to an earphone with adjustable area of sound holes on a housing behind a speaker.

2. Description of Related Art

With the rapid progress of the science and technology, the electronic product has gradually become light, chic and miniaturized, and people can use the miniaturized electronic products, such as radio or walkman, at anytime and anywhere. Moreover, the personal digital product, such as common MP3 walkmans, cell phones, personal digital assistants (PDAs) or notebooks, has increasingly become popular, and thus being indispensable in the daily life. In addition, the cell phone integrated with functions of both radio and MP3 has immerged.

No matter what kind of electronic products, the earphone has become an essential fitting for the electronic product, so the user can listen to the sound information provided by the electronic product without interfering others. Moreover, the earphone also provides a preferable sound transmission for the listener, such that he/she can hear and understand the content of the sound more clearly, unlike the circumstance that the sound is unclear when transmitting from computer speakers. Especially, when the user is moving, for example, when doing exercises, driving, conducting acute motions or in a noisy environment, since the earphone is used, the sound transmission will not be influenced.

However, since the size and structure of the ear and the ear canal are different from person to person, and a different person has a different favor for the music, thus, the judgment for the sound quality of the earphone varies as for different persons, and it is hard to meet the requirements of each person. Meanwhile, the frequency response curve of most earphones available in the market is fixed, and if the frequency response on high tone portion or low tone portion of the signal is to be changed, it requires changing the distribution characteristics of the sound field by an electronic equalizer or relevant software. Even though the additional electronic equalizer may change the frequency response of the earphone, the time delay caused by the inductance or capacitance within the electronic equalizer cannot be compensated. Therefore, it is an unavoidable task to improve the structure of the earphone.

### SUMMARY OF THE INVENTION

An objective of the present invention is to provide an earphone with adjustable area of sound holes on a housing behind the speaker, so as to change the sound field characteristic of the earphone body in structure.

The present invention provides an earphone with adjustable area of sound holes on a housing behind the speaker, which comprises: a speaker unit, a housing and a cover plate. The speaker unit is covered by the housing having at least one adjustable sound hole located thereon behind the speaker unit. Moreover, the cover plate is disposed on the housing, and selectively covers at least one of the adjustable sound holes.

According to an embodiment of the present invention, the cover plate is a pivoting plate with an axle center being pivotally connected to the housing, such that the pivoting plate rotatably shields at least one of the adjustable sound holes. In this embodiment, the pivoting plate comprises a fan-shaped plate.

According to an embodiment of the present invention, the cover plate is a sliding plate, the housing has a slot correspondingly, and the sliding plate is engaged in the slot, and thereby slidably shielding at least one of the adjustable sound holes. In this embodiment, the sliding plate comprises a bar plate.

The present invention employs an adjustment structure disposed behind the earphone body, which shields a part of the adjustable sound holes with a rotatable or slidable cover plate, so as to change the sound field characteristic of the earphone body. Therefore, each person may adjust the frequency response of the earphone body directing to different music, such that the earphone may meet different customers' requirements.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of an earphone with adjustable area of sound holes on a housing behind the speaker according to a preferred 7 embodiment of the present invention.

FIG. 2 is a frequency response curve diagram of the area of the adjustable sound hole on sound field characteristics of the earphone.

FIG. 3 is a schematic view of a rotatable cover plate according to an embodiment of the present invention.

FIG. 4 is a schematic view of a slidable cover plate according to another embodiment of the present invention.

FIG. 5 is a schematic view of an adjustable sound hole and a cover plate according to another embodiment of the present invention.

### DESCRIPTION OF EMBODIMENTS

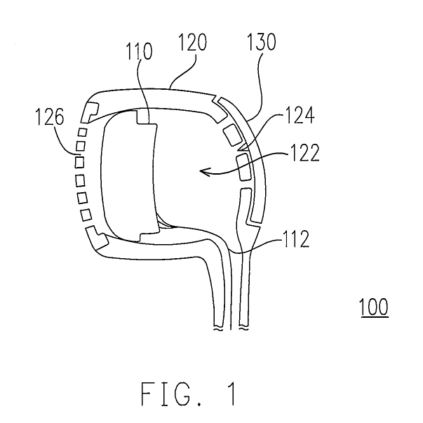

Referring to FIG. 1, it is a schematic cross-sectional view of an earphone with adjustable area of sound holes on a housing behind the speaker according to a preferred embodiment of the present invention. A speaker unit 110 is disposed within an earphone housing 120, and is electrically connected to an external host (e.g., MP3 player, cell phone, walkman or computer) via a transmission line 112, such that the speaker unit 110 can send out sound information that is acceptable for the human ear. The internal structure of the speaker unit 110 is not shown in FIG. 1. The profile size of the speaker unit 110 substantially matches with the volume of the internal chamber of the earphone housing 120, and the speaker unit 110 can be inserted into the cochlea of the human ear (not shown), thus, this type of earphone 100 is generally referred as a micro earphone or an in-ear type earphone. However, the earphone 100 with adjustable area of sound holes on a housing behind the speaker of the present invention may be widely applied in various types of earphones, and is not limited to the micro earphone or the in-ear type earphone as shown in FIG. 1.

As shown in FIG. 1, the earphone housing 120 forms a rear chamber 122 behind the speaker unit 110 for generating a resonance effect, such that the sound field characteristic of the sound sent by the speaker unit 110 is different in the rear chamber 122. For example, the frequency response of high tone portion or low tone portion is changed to make either the high tone portion or the low tone portion outstanding on the curve of the frequency response. Generally, when designing the sound field characteristic of the earphone, the adjustable sound holes 124 are also taken into consideration. The adjustable sound holes 124 are not the main sound holes 126 disposed at the front of the earphone housing 120 for being put into the ear, but are distributed on the housing 120 behind the speaker unit 110, which also influence the sound field characteristics of the earphone like the volume of the rear chamber 122. Therefore, the number and position of the adjustable sound holes 124 and the size of the exposed area of the adjustable sound holes 124 also influence the frequency response of the high tone portion or the low tone portion.

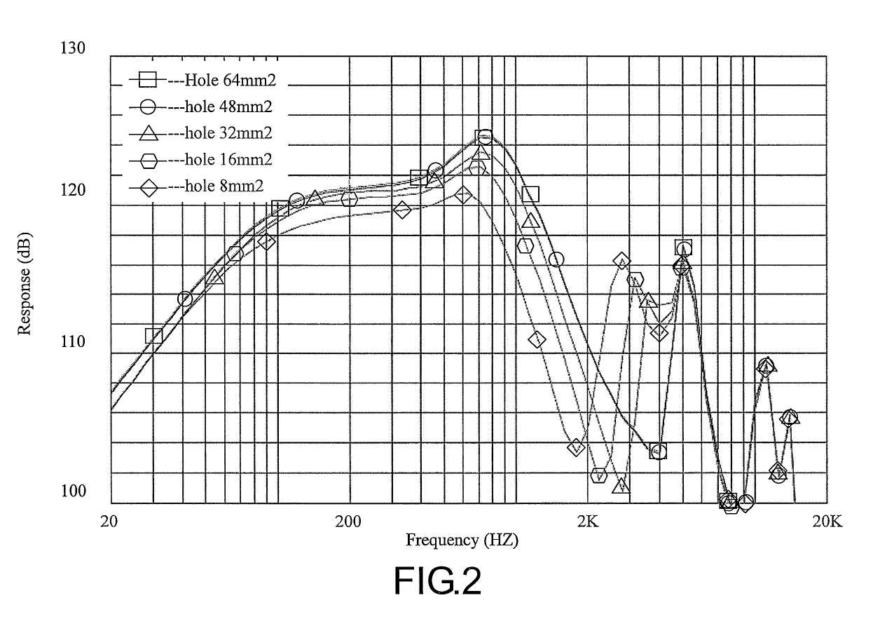

Referring to FIG. 2, it is a frequency response curve diagram of the size of the adjustable sound hole on sound field characteristics of the earphone. Difference frequency response curves are presented with different symbols. Within the audio frequency range that can be heard by human ear (20 Hz-20 KHz), it is known from the result of an artificial ear test that, the adjustable sound hole with a small exposed area (e.g., 8 mm²) is outstanding for the frequency response of the high-frequency portion, whereas the adjustable sound hole with a large exposed area (e.g., 64 mm²) is outstanding for the frequency response of the low-frequency portion. Other adjustable sound holes with an exposed area of between 8 mm² and 64 mm² also have special performances in terms of the sound field characteristics. Therefore, the frequency response curve diagrams of adjustable sound holes with different exposed areas are different. If the adjustable sound holes only have a fixed exposed area, and cannot be adjusted as desired, the function of the adjustable sound holes is restricted, thus, the performance cannot be further improved.

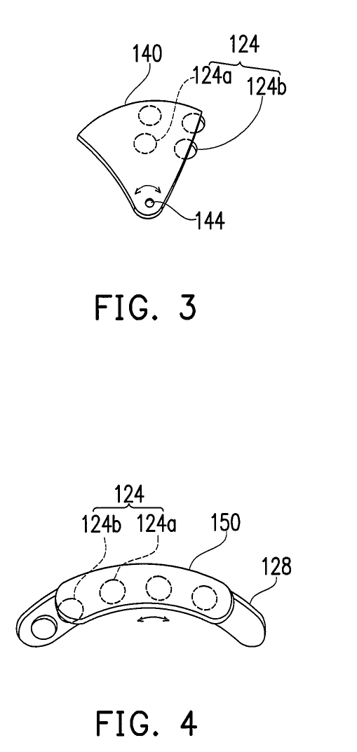

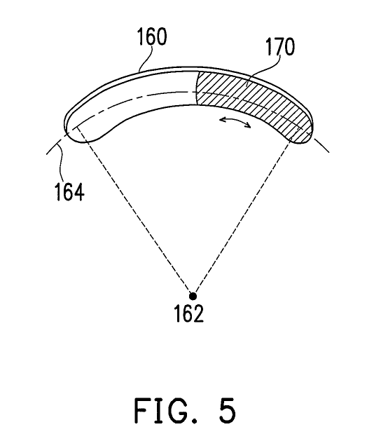

Therefore, the earphone 100 of the present invention employs an adjustment mechanism for adjusting the area of the sound hole on the housing behind the speaker, which shields a part of the adjustable sound holes 124 or a part of the area of a single adjustable sound hole 124 with a rotatable or slidable cover plate 130, so as to overcome the above problems. FIG. 3 is a schematic view of a rotatable cover plate according to an embodiment of the present invention, and FIG. 4 is a schematic view of a slidable cover plate according to another embodiment of the present invention.

As shown in FIG. 3, the cover plate 130 of FIG. 2 is, for example, a pivoting plate 140 matching with the profile of the second half of the earphone housing 120, which may be fan-shaped, semicircular or oval-shaped, but not limited to this. Taking the fan-shaped pivoting plate as an example, the axle center 144 of the pivoting plate 140 is pivotally connected to the earphone housing 120, such that the pivoting plate 140 rotatably covers at least one of the adjustable sound holes 124, wherein the adjustable sound holes 124a indicated by a dash-line in the figure represents that it is totally covered by the pivoting plate 140, and the adjustable sound holes 124b partly indicated by a solid line and a dash line represents that it is partly covered by the pivoting plate 140. Therefore, the exposed area of the adjustable sound holes 124 may be selectively adjusted according to the demand of the user, so as to meet different customers' requirements for the earphone sound field characteristics.

Then, referring to FIG. 4, the cover plate 130 of FIG. 2 is, for example, a sliding plate 150, and the earphone housing 120 has a slot 128 correspondingly, such that the sliding plate 150 slides from one end of the slot 128 of the earphone housing 120 to the other end. The sliding plate 150 is, e.g., a bar plate, such as an arc plate or a circular plate, such that the sliding plate 150 slidably covers at least one of the adjustable sound holes 124, wherein the adjustable sound holes 124a indicated by a dash line in the figure represents that it is totally covered by the sliding plate 150, and the adjustable sound hole 124b partly indicated by a solid line and a dash line represents that it is partly covered by the sliding plate 150. Therefore, the exposed area of the adjustable sound holes 124 may be selectively adjusted according to the demand of the user, so as to meet different customers' requirements for the earphone sound field characteristics.

Besides the circular hole, the adjustable sound hole 124 may be an arc hole 160 as shown in another embodiment of FIG. 5. The arc hole 160 is not limited to be only one, but may comprise a plurality of arc holes arranged in concentric circles, or a plurality of arc holes sequentially arranged in concentric circles with different radiuses. Taking a single arc hole 160 as an example, the cover plate 170 may also select the above pivoting plate 140 or the sliding plate 150 to adjust the exposed area of the arc hole 160 (the area covered by the cover plate 170 is indicated by an inclined line), so as to obtain different sound field characteristics corresponding to different exposed areas. In this embodiment, the cover plate 170 may be located within the housing, and exposed in the arc hole 160. When the cover plate 170 is a pivoting plate, it rotates with the center 162 of the arc hole 160 as an axle center, thus, the exposed area of the arc hole 160 is adjusted by changing the rotation angle. In addition, when the cover plate 170 is a sliding plate, the sliding plate moves along the centerline 164 of the arc hole 160, thus, the exposed area of the arc hole 160 is adjusted by changing the moving distance.

To sum up, the earphone with adjustable area of sound holes on a housing behind the speaker according to the present invention comprises a speaker unit, a housing and a cover plate, wherein the cover plate is disposed on the adjustable sound hole(s) behind the housing for selectively shielding at least one of the adjustable sound holes. The sound field characteristic of the sound sent by the speaker unit in the rear chamber varies depending upon different exposed areas and positions of the adjustable sound holes, thus, the present invention changes the sound field characteristic of the earphone body by shielding a part of the adjustable sound holes or a part of the area of a single adjustable sound hole with a rotatable or slidable cover plate in terms of the structure of the earphone body. Therefore, each person may adjust the frequency response of the earphone body directing to different music, such that the earphone can meet different customers' requirements.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An earphone with adjustable area of sound holes on a housing behind the speaker, comprising:
a speaker unit;
a housing, covering the speaker unit and having at least an adjustable sound hole disposed thereon behind the speaker unit; and
a cover plate, disposed on the housing, for selectively shielding at least one of the adjustable sound holes.

2. The earphone with adjustable area of sound holes on a housing behind the speaker as claimed in claim 1, wherein the cover plate is a pivoting plate with an axle center being pivotally connected to the housing, such that the pivoting plate rotatably shields at least one of the adjustable sound holes.

3. The earphone with adjustable area of sound holes on a housing behind the speaker as claimed in claim 2, wherein the pivoting plate comprises a fan-shaped plate.

4. The earphone with adjustable area of sound holes on a housing behind the speaker as claimed in claim 2, wherein the adjustable sound hole comprises a circular hole or an arc hole.

5. The earphone with adjustable area of sound holes on a housing behind the speaker as claimed in claim 1, wherein the cover plate is a sliding plate, the housing has a slot correspondingly, and the sliding plate is engaged in the slot and slidably shields at least one of the adjustable sound holes.

6. The earphone with adjustable area of sound holes on a housing behind the speaker as claimed in claim 5, wherein the sliding plate comprises a bar plate.

7. The earphone with adjustable area of sound holes on a housing behind the speaker as claimed in claim 5, wherein the adjustable sound hole comprises a circular hole or an arc hole.

8. The earphone with adjustable area of sound holes on a housing behind the speaker as claimed in claim 1, wherein the adjustable sound hole comprises a circular hole or an arc hole.

9. The earphone with adjustable area of sound holes on a housing behind the speaker as claimed in claim 1, wherein the size of the speaker unit is suitable to be inserted into an ear.
